(19) United States
(12) Patent Application Publication
(10) Pub. No.: US 2022/0207465 A1
(43) Pub. Date: Jun. 30, 2022

(54) System, Method, and Platform for Determining Optimal Equipment Purchase and Installation Parameters Using Neural Networks

(71) Applicant: 3C USA LLC, New York, NY (US)

(72) Inventors: David Anthony Collard, New York, NY (US); Kyle Makinen, New York, NY (US); Angus Beeforth, Victoria (AU); Todd Noller, Victoria (AU); Scott N. Barnett, Victoria (AU); Rohan Liston, Victoria (AU); Venkata Rajesh Vasa, Victoria (AU); Andrew Vouliotis, Victoria (AU)

(21) Appl. No.: 17/565,417

(22) Filed: Dec. 29, 2021

Related U.S. Application Data
(60) Provisional application No. 63/131,759, filed on Dec. 29, 2020.

(51) Int. Cl. G06Q 10/08; G06Q 50/20; G06N 3/08

(52) U.S. Cl. CPC G06Q 10/087; G06N 3/08; G06Q 50/20

(57) ABSTRACT

A system of neural networks and data acquisition components, modification components configured to receive information about supply requirements, calculate and confirm additional information about supply requirements, and continuously incorporate any changes to the information calculated additional information, and changes to the additional information into training data to improve neural network predictions.

### PRIORITY CLAIM

This non-provisional application claims the benefit and priority of U.S. provisional patent application 63/131759, filed Dec. 29, 2020. The above referenced application is incorporated herein by reference as if restated in full.

### BACKGROUND

Due to supply chain issues, particularly those triggered at least in part by global pandemics, it has become increasingly vital that businesses, schools, government offices, and other location-based enterprises and organizations secure sufficient supplies of necessary products—particularly personal protective equipment and inventory. In addition, governments have enacted and continue to enact rules and regulations requiring certain personal protective equipment and inventory to be on hand. Unfortunately, it is tedious and complicated to comply with such rules and regulations because of general ambiguity in the rules and regulations themselves, the lack of knowledge as to where an earnest supply manager can find them, and the inherent difficulty in applying rules and regulations to one's own concerns, which often depend on many factors concerning a business or other organization. What is needed is a platform to enable buyers to find suppliers and obtain both knowledge and supplies in one place, suppliers to provide access to their supplies, and methods to automate as much as possible the correct purchase of supplies based on the unique needs of the business or organization.

### SUMMARY

The system is configured to predict product supply requirements and provide product supply recommendations. The system comprises a data acquisition component, a set of neural networks, training data acquisition components, a marketplace platform, and user modification components. The components have user interfaces for receiving instructions and data entries from users. The data acquisition component is configured to receive details pertaining to a set of locations for which supply is required. A location parameter prediction neural network is configured to predict additional details about those locations in order to reduce the burden of gathering and entering details by the users. The modification components enable the user to change the predicted additional details, and the modifications are sent to the training data acquisition component to be added to training data for future training of the location parameter prediction neural network.

A product supply requirement prediction neural network is configured to receive the location details and calculate the product supply requirements for the locations. The modification components enable the user to change the results of the predictions, and the modifications are transmitted to the training data acquisition component to be added to training data for future training of the product supply requirement prediction neural network.

The marketplace platform is configured to receive the predictions and changes thereof, enabling the user to purchase the corresponding products for each location.

### BRIEF DESCRIPTION OF THE FIGURES

FIG. 1a is a diagram showing an exemplary system configuration, including buyer and seller portals and neural networks configured to make predictions for the buyer's supply needs based on location parameters.

FIG. 1b is a flowchart showing an exemplary location data acquisition and product recommendation process.

FIG. 2 is a flowchart showing an exemplary floorplan analysis and a product recommendation process.

FIG. 3a is a flowchart showing as exemplary overview of training preparing for a neural network process.

FIG. 3b is a flowchart showing an exemplary floorplan processing and neural network data entry process.

FIG. 3c is a flowchart showing an exemplary training process for a neural network configured to analyze floorplan data.

FIG. 4 is a flowchart showing an exemplary floorplan pre-processing and neural network data entry process.

FIG. 5 is a flowchart showing an exemplary process for pre-processing data for neural network entry.

FIG. 6 is a flowchart showing exemplary pre-processing and neural network processing.

FIG. 7 is a diagram showing an exemplary product requirement prediction system.

FIG. 8a is a diagram showing an exemplary neural network training and configuration process.

FIG. 8b is a diagram showing an exemplary location parameter prediction neural network process and product requirement prediction neural network process.

### DETAILED DESCRIPTION

The present invention may comprise a platform, a system, and a set of methods. The present invention may also comprise a non-transitory computer-readable storage medium encoded with instructions to cause at least one processor of a computing device to perform any of the methods, run any of the platforms, or provide processing and power for any of the systems described below. The computing device may comprise a display device to display various features of the platform on a user interface and at least one input device configured to receive instructions from a user of the platform and system.

The platform may feature a buyer portal and a supplier portal, with the portals designed to be navigated by buyers of inventory and equipment, and suppliers of inventory and equipment, respectively. For both buyer and supplier portals, the platform may comprise a user account creation or login interface, enabling the user to enter or create account credentials which are then saved to an account database. Account management, which includes account creation and authentication, may be handled using the .NET core framework. Information about the user, in addition to the username and password, may be made available to the user for viewing and updating. Updates are transmitted and saved to the account database. There may be an initial platform interface permitting a user to identify as a buyer or a supplier. The buyer and supplier accounts may be kept separate, but in one variation, a user may have a single account as a buyer and as a supplier and may engage in all platform activity via a unified interface.

The buyer portal may comprise an industry interface, which is configured to receive user selections of industries which categorize or otherwise describe their business or organization. User selections may be made via checking check boxes, dragging and dropping, or any other method of distinguishing industries that apply from industries that do not.

The buyer portal may comprise a locations interface, which is configured to receiver user selections of the physical locations where their business or organization operates. The locations interface may feature a drop down menu or an input field, permitting users to select or enter the quantity of locations. The locations interface may in turn display address blocks for each location, which may be filled manually or through an auto-loading mechanism. The locations interface may also feature a map which has a reciprocal relationship with the address blocks and location quantity, i.e., the map may populate with pins corresponding to the addresses and which in turn may be adjusted, thereby adjusting the address. The map may also receive pin creations or deletions, thereby increasing or deleting the quantity of locations and address blocks. Locations may be categorized or characterized by the platform according to their geographic area, legal jurisdiction, demographic data, language, weather, season, population density, zoning, and/or other important descriptors. These location categories and characteristics, once determined by the platform, may be displayed by the platform in such a way as to enable user verification thereof, or alternately, merely user recognition thereof. Verification may occur passively or may require the user to actively select a button that corresponds to user verification. Alternately, the platform may receive challenges from the user as to proper categorization and characterization, and may also receive from the user corrections thereof.

The buyer portal may provide a matching interface, enabling the user to identify which industries apply to which locations. As will be discussed later, locations may be understood as comprising one or more floors and visualized by floor plans. The matching interface may permit the user to assign an industry to an entire location, and then assign different industries to discrete floors thereof, and then assign different industries to discrete rooms thereof.

The buyer portal may comprise a questions interface, which is configured to pose a set of questions for the user based on the industries and locations selected. A first set of questions may be generic, applicable across all industries and location categories/characteristics. One or more subsequent question sets may be specific to one or more industries and/or locations. Questions may pertain to the real property, such as the building(s) and lot(s), e.g., the number of floors, the average number of occupants per floor, the average number of entry points per floor, the average number of visitors, the average visitor duration of stay, the number of bathrooms, kitchens, reception rooms, etc. Questions may pertain to the use of the property, or the use may be inferred by the industries selected and merely provide the user the opportunity to confirm the use thereof.

Questions may be organized by the locations to which they pertain, with a visualization indicating which location any given set of questions are directed toward. Other questions may be directed not toward a location but the business itself, including questions about the corporate structure, the total number of employees across locations, and so on.

The questions interface may provide documentation upload fields, permitting the user to upload documents containing information from which answers to the questions previously described can be calculated or otherwise determined by the platform rather than imposing the requirement on the user to answer every single question. Documentation may be in an appropriate format such as spreadsheets or text documents. The questions interface may provide the user access to downloadable template spreadsheets with the potential categories or characteristics of locations arranged in rows, columns, or cells to facilitate the process. The template spreadsheet may enable the user to select an industry relevant to each location, or multiple industries if so applicable, as well as any of the other instantiations previously discussed. Documentation may also be in the form of image files so as to enable the uploading of floor plans. Floor plan documentation may be utilized by the platform to identify instantiations of characteristics pertaining to the location as previously described and to assist in various calculations, particularly those based on square footage.

The buyer portal may comprise a quotation interface which sub-cedes the industries and locations interfaces. The quotation interface may be accessed by the user by requesting it while navigating the aforementioned interfaces. The request may be in the form of clicking an adequately labeled button such as “Generate Quote”.

The transition unto the quotation interface may include an artificial loading time. The artificial loading time may resemble a conventional loading time, which is designed to communicate to a user the actual progress that software is making in completing a task such as saving data or loading a feature; however, the artificial loading time in this instance may be designed to create the impression that specific tasks are computationally expensive and therefore require a non-trivial usage of time or resources. In particular, the artificial loading time may be designed to communicate to the user that the user's data is being individually interpreted and analyzed, and that answers, solutions, or proposals being generated are customized as opposed to generic. The artificial loading time may be displayed as a pop-up on the quotation interface, and include the progress bar along with several statements of text adjacent thereto. The text may include, for example, “Analyzing thousands of past customers orders . . . ”, “Cross-referencing regulatory guidance . . . ”, “Calculating employee time impact . . . ”, and finally, “Complete”.

The quotation interface may display a list or map of the locations along with a list of recommendations for those locations. The platform may filter the recommendations for a given set of location upon receiving a user selection of one or more locations. Recommendations may also be filtered by location categories and/or characteristics—for example, the platform may receive from the user a request to display only recommendations for locations in particular jurisdictions or geographic areas, such as “Sydney”, or more broadly still, “Australia”.

Recommendations may pertain to the purchase of supplies and equipment, such as hand sanitizer and hand sanitizer stations. The identification of these items and their respective quantities may form a list, with the item and quantity subject to modification by the user. To assist the user, the platform may permit filtering of the recommendations based on supply or equipment category. The supplies or equipment that are not filtered out may, so to speak, be “kept”, effectively forming the content of the user's cart.

Recommendations may also be filtered based on secondary features of the supplies and equipment, such as their geographic source, or price. One example of a secondary feature filtering mechanism provided to the user is the choice between “Locally made” and “Lowest cost”, with the former restricting supplies and equipment to those which are made in the same jurisdiction, country, or within a pre-set geographical distance from one or more of the locations identified by the user, and with the latter selecting goods that are the cheapest option based on unit cost and/or estimated shipping cost to the designated location, regardless of their source.

Recommendations may be itemized according to discrete locations, with recommendations visually separated according to the location to which they pertain. A visual representation of the location may be shown adjacent to the location-limited recommendations, and it may include a visualization of the location floorplan via a floorplan interface, when applicable. The floorplan for a single floor may be shown two-dimensionally, whereas a floorplan with multiple floors may be shown in two dimensional layers arranged via a perspective view in a three-dimensional pile, with each floor displayed in a semi-transparent fashion, thereby permitting the user to view the floor below while still being able to observe the floor above. The floorplan interface may receive a user selection of a particular floor in the three-dimensional pile, which may decrease the opacity of floors above it, thereby providing the user a cleaner view of the selected floor. In one variation, the floorplan interface may receive a request from the user to alternate the view between a two-dimensional view of a single floor and a three-dimensional view of multiple floors. The floorplan interface may provide zooming features to enable the user to consider granular details when evaluating the placement of equipment, as will be described later. The floorplan interface may provide a first-person perspective view of a floor, so that the user can have the experience of walking through their floor to assist in the evaluation just described. The floorplan interface may populate the first-person perspective view with all of the details of the floorplan, such as the presence of doors, windows, etc.

In one variation, the floorplan interface is configured to receive video recordings, possibly made by a person or drone, in which the floor plan is navigated while being filmed. The platform may process this first-person recording in order to create a floorplan layout. In this variation, the first-person perspective view may include details found in the video recording, such as the color of the wallpaper and the arrangement of sofas, thereby considerably enhancing considerably the realism of the perspective view. In place of video recordings, a laser-scan map may be used, in which the distances between walls and the presence of obstacles therein are captured by three-dimensional laser-scan technology.

The floorplan visualization may feature pins indicating the location of recommended equipment. These pins may be color coded or shaped like their corresponding equipment type—for example, a hand sanitizer dispensing station may be shaped like a dispensing station. The platform may permit the user to modify the location of the pin by dragging it, change its equipment category, or delete it. The platform may similarly permit the user to add additional pins in desired locations by double-clicking on the floorplan or otherwise indicating that the user wishes to add a pin.

In addition to equipment being visually represented as pins, equipment may also be represented in what could be described as equipment cards, with an equipment card featuring a picture and description of the equipment, as well as the quantity recommended. By selecting the equipment card, all of pins corresponding to the equipment card may be highlighted. By selecting a “cycle” key on a given equipment card, the pins are sequentially highlighted.

As described previously, the platform may provide an equipment filter in order to alternately display and not display various equipment or supply categories. The platform may also permit another equipment filter which filters equipment based on the floor in which the platform recommends equipment installation or supply—i.e., the user can select a given floor, and only equipment for that floor will be displayed. This filtering may affect both pins and equipment cards.

The floorplan interface may include a designation of the location associated with the visualized floorplans. For example, the designation may be “Location #1”, to correspond to the first location, but if Location #1 has been labeled by the platform or the user, the label will appear instead—i.e., the user may label Location #1 as “the main building” or the platform may label it based on one or more of the categories or characterizations pertaining to it, such as “NYC, Education, School, #3”. The designation location may be changed by the user by selecting a new designation via a drop-down menu. For example, the user could select “Location #2” (or whatever it has been labeled) in order to view the floorplan and recommendations for the second location.

The buyer portal may include an installation fee calculation interface. The platform may receive user requests to itemize the calculation according to various categories, such as by location, by floor, by industry, or by equipment or supply type. These user requests may manifest as selections of buttons corresponding to these categories. The platform may also permit the user to make selections of discrete installation services, including the option to select all or select none.

The buyer portal may provide a shipping destination interface, which permits a user to identify the location(s) to which the supplies and equipment are to be shipped. The platform may update in real time the shipping price and the total price based on how the supplies and equipment are allocated. Initially, the shipping destination interface may set the shipping destinations based on the supplies and equipment recommendations, but may permit the user to move quantities of supplies and equipment from one location to another by operations such as dragging and dropping supply or equipment icons, identifying a quantity to be moved, and setting or otherwise fixing the quantity for a given location. The platform may provide the user the option to reset the quantities to their defaults—i.e., the recommendations—and also to save the user-defined allocations, thereby giving the user the option to compare the default with the user-defined allocations. The platform may display not only the total price based on the equipment, services, installation fees, and shipping, but also the estimated time required to receive the supplies and equipment, stock the supplies, and install the equipment. Finally, the platform may receive a final approval from the user to execute the order. This final approval may be in the form of a “Submit” button disposed adjacently to the total price.

The buyer portal may provide a navigation bar which pervades the various interfaces thereof. In particular, the navigation bar may provide one-click access to the questions interface, the quotations interface, the floorplans interface, as well as guidance and terms and conditions interfaces.

The buyer portal may provide a guidance interface, which populates rules, regulations, and advise for the user based on the locations entered. The rules, regulations, and advise may be organized by the jurisdictions pertaining to the locations, with identification of the corresponding locations disposed adjacently thereto. Sources containing rules or regulations, such as government web pages, may be hyperlinked. In one variation, the relevant sections of the web pages may be embedded in a buyer portal pop-up with important text highlighted, so that the user can review the source information without having to leave the platform.

The buyer portal may provide a human-time impact interface, which is configured to calculate, using answers provided in the questions interface, the jurisdictions implied by the locations entered in the locations interface, and the square footage and room layout provided in the floorplant interface, how social distancing requirements, et. al., will impact (i.e., increase) the hours required to perform for the operation of the business.

The buyer portal may provide a reporting interface, which receives one or more email addresses from the user, to which it sends a report detailing the various parts discussed above—namely, the industries and locations designated, the equipment and supplies recommended, and the pricing, in both an overview form as well as an itemized version thereof. In one variation, the report is made available to download via the reporting interface. The report and the details therein may be saved to the user's account for later access.

The supplier portal may provide an inventory designation interface, which is configured to permit suppliers to identify the supplies and equipment that they can supply to buyers using the platform. The inventory designation interface may have a list of existing inventory which the supplier may select as willing to offer, with the list being organized by inventory type, searchable by keywords, and tagged with corresponding UPC codes. The inventory designation interface may also provide a supplier the ability to create a new inventory listing, including inventory attributes, such as an inventory title, dimensions, branding information, as well as any other relevant information pertaining to that item, such as images.

The inventory designation interface may create a unique supplier code matching each supplier to each given inventory type offered by the supplier, as well as inventory codes which are fixed with respect to a given inventory type regardless of which suppliers are offering to supply it. The inventory designation interface may receive from the supplier quantity and sourcing information for each inventory type, which would then be associated with the corresponding supplier code. The sourcing information would identify the geographic area in which the inventory was manufactured, in order to assist buyers using the platform who wish to limit their purchases to locally made goods. The quantity associated with each supplier code would decrease as inventory is sold or otherwise updated by the supplier. In one variation, the inventory designation interface may provide a downloadable template to the supplier, which would enable the supplier to communicate all inventory updates without having to manually enter the information into the inventory designation interface. A completed template could be uploaded to the inventory designation interface, and the platform would execute the updates according to the template.

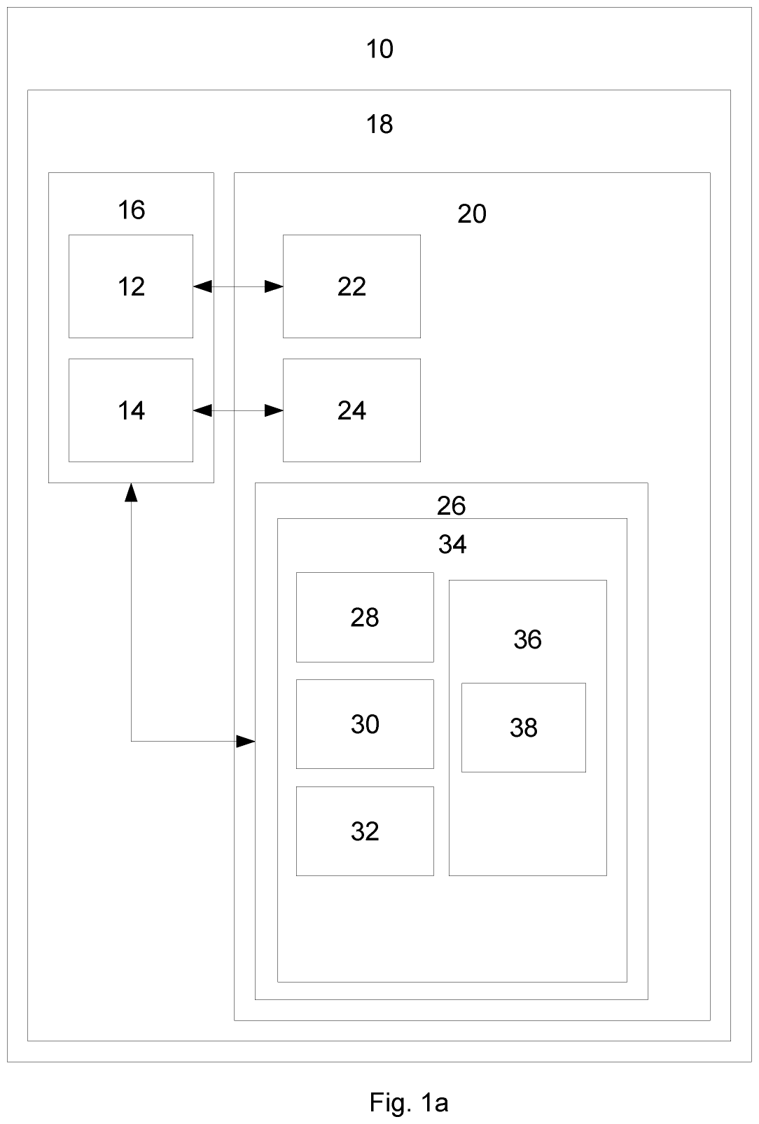

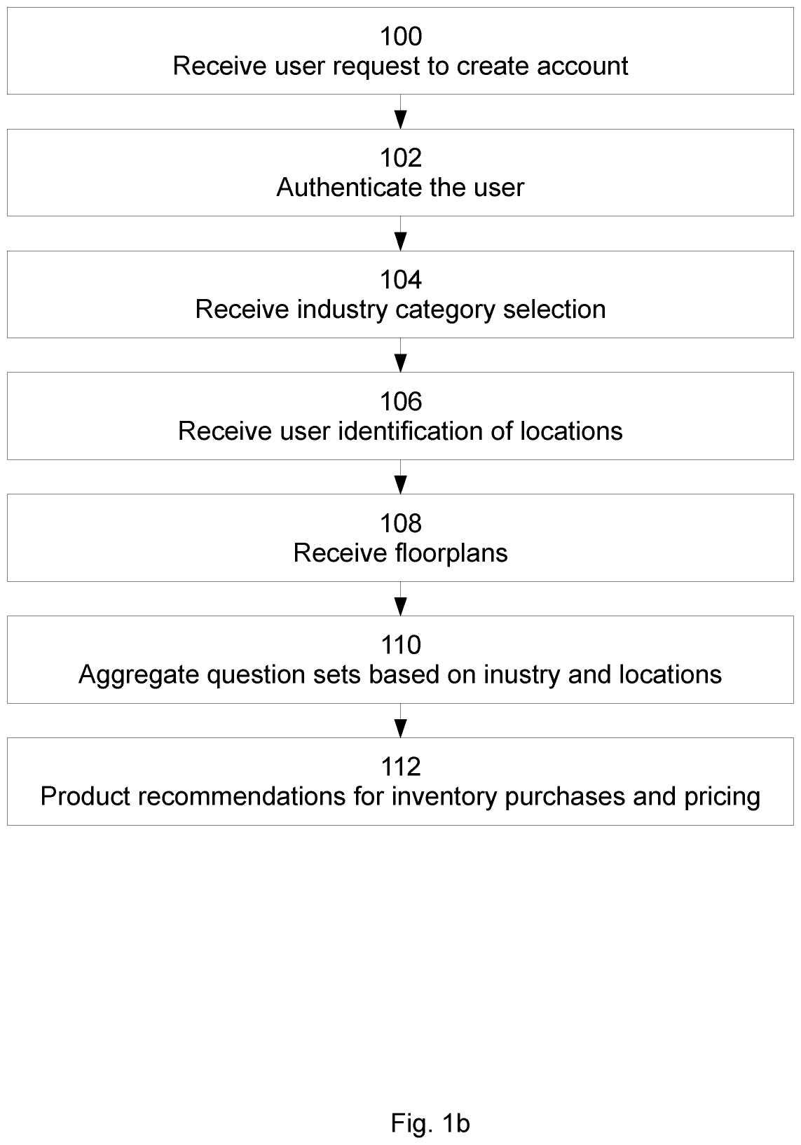

As shown in FIG. 1a, the system 10 may comprise a buyer portal 12 and a supplier portal 14 forming a platform 16. The platform may operate across one or more networks 18 comprising a plurality of computer systems 20, including a set of computer systems operated by buyers 22, a set of computer systems operated by suppliers 24, and a set of computer systems operated by administrators 26, with each computer system comprising at least one processor and one or more memory structures. A user account database 28, an inventory database 30, and a rules and regulations database 32 may be stored on the one or more administrator computer systems, which may at least in part reside in the cloud 34. Some subset 36 of the set of administrator computer systems may provide the computing power for computationally intensive Artificial Intelligence programs 38, particularly neural networks which may require continual training.

A neural network is a computer algorithm which can be trained via training data to learn features of data in input streams and associate some set of this input data with output data. After learning is complete, or at least sufficiently complete, the neural network can predict output data for some set of input data not present in the training data.

The neural networks in the present application may be arranged in a sequence such that the output of one neural network becomes the input of another neural network. The input of the second neural network may be joined by a second stream of output data derived from a non-neural network, such as a platform or system component configured to receive data or selections from a platform or system user and perform non-neural analysis upon the data or selections. Training data for one neural network may also be formed at least in part by the output of another neural network. Since the neural networks may operate continuously by receiving input data in real-time, additional training may also occur in real-time, particularly as one neural network may create training data for the other neural network and vice versa.

As shown in FIG. 1b, the method may comprise the steps of receiving a user request to create an account or login 100, establish an account and/or authenticate the users 102, receive industry category selection(s) from the user 104, receive a user identification of locations 106, receive a set of floorplans for each location 108, aggregating question sets based on the industries and locations identified by the user 110, activate a corresponding set of data-acquisition, computation, and communication algorithms to produce recommendations for inventory purchases and pricing 112.

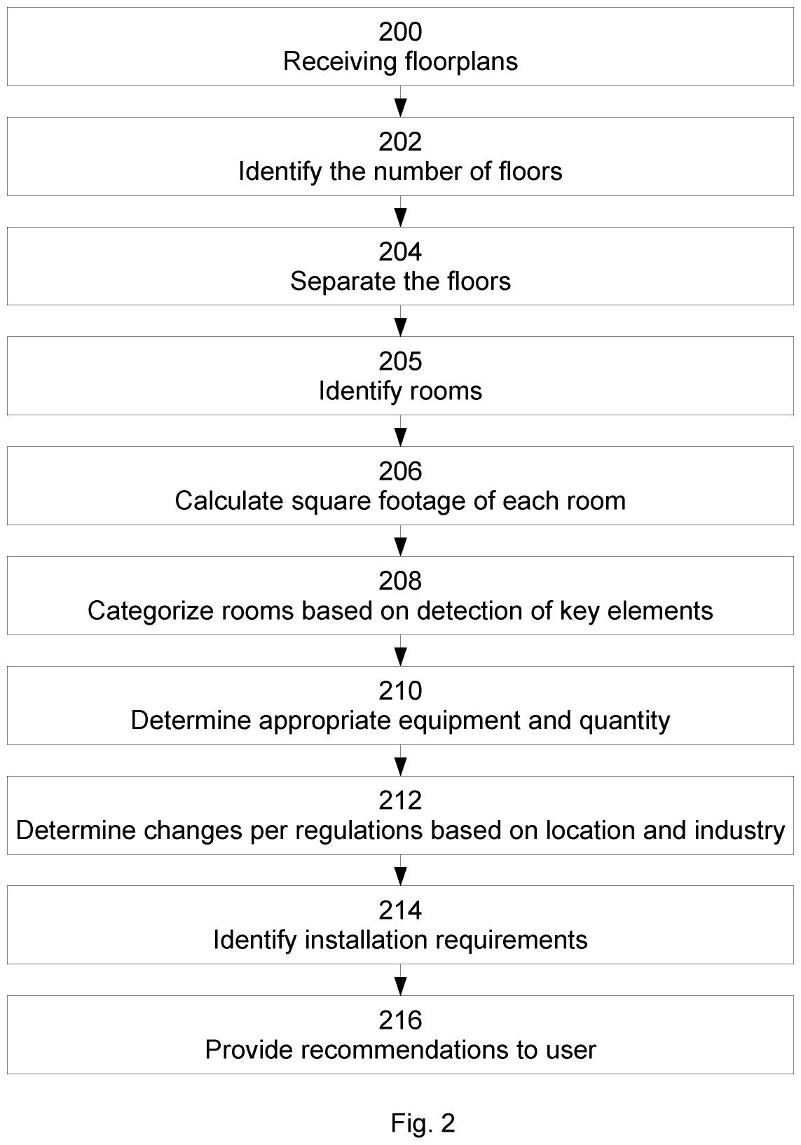

As shown in FIG. 2, the method may include the steps of receiving floorplans for a given location 200, identify the number of floors 202, separate the floors 204, identify the rooms by detecting entrances 205, calculate the square footage of each room 206, categorize the rooms on each floor based on the detection of key elements, e.g., the presence of a sink 208, determine appropriate equipment and the quantity of equipment units based on the category and square footage of each room 210, determine adjustments thereto based on government rules and regulations pertaining to the jurisdiction and industry selection for the location 212, identify points where the equipment units should be installed 214, provide equipment recommendations to the user 216.

In place of conventional algorithms, the system may rely on neural networks to make predictions, recommendations, and other determinations for the platform.

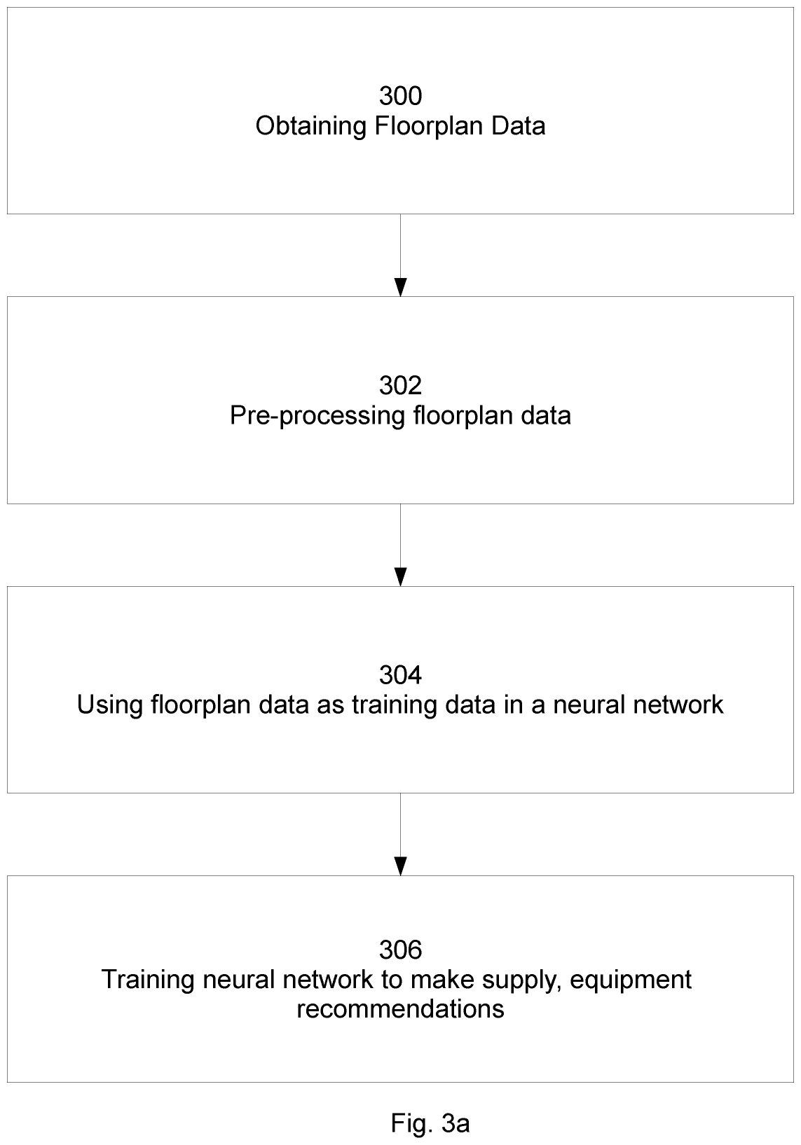

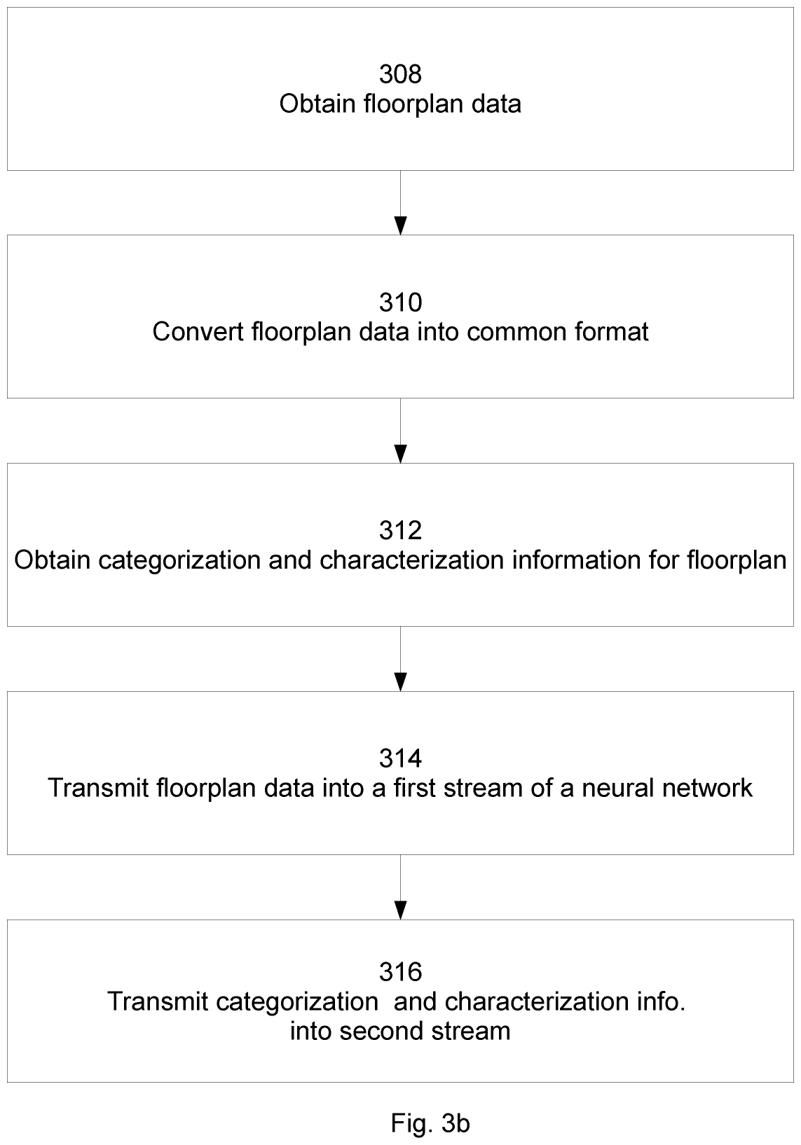

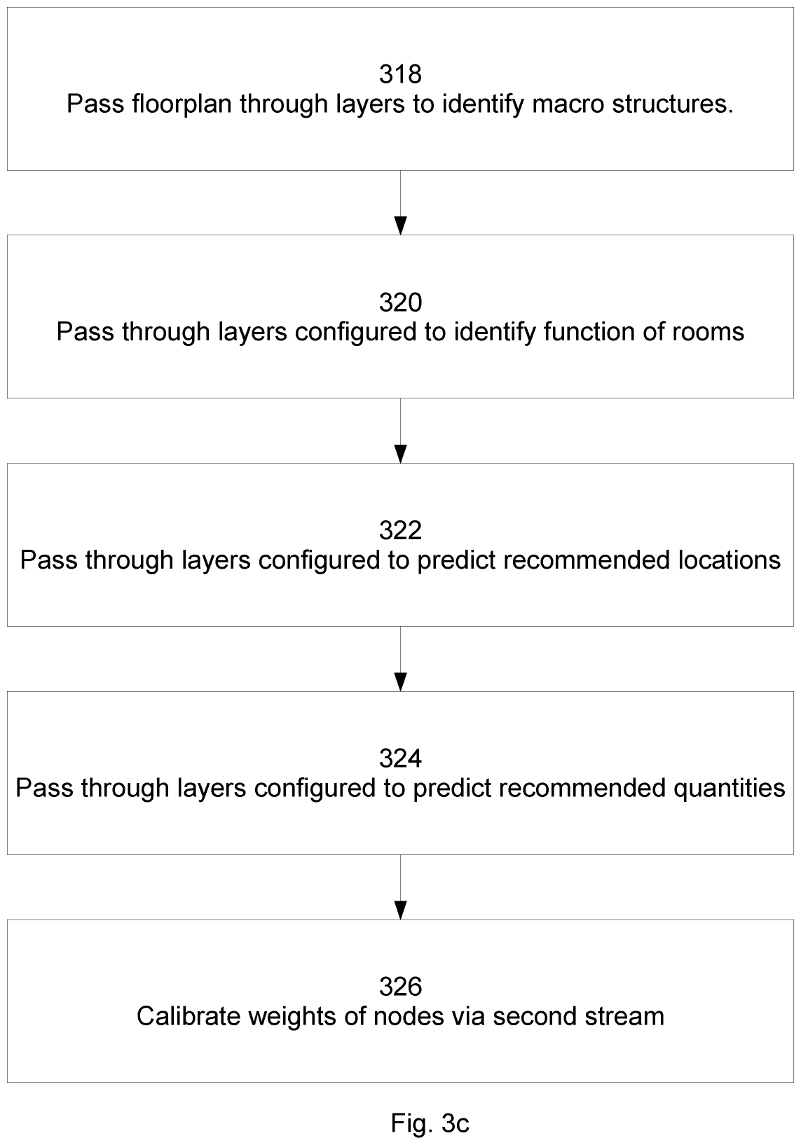

As shown in FIG. 3a, the neural network configured to make equipment recommendations may include the high-level steps of obtaining floorplan data 300, preprocessing the floorplan data 302, using the floorplan data as training data in a neural network 304, training the neural network to make supply and equipment recommendations 306. The neural network here may be an image recognition neural network using the structure of a Convolutional Neural Network (CNN).

As shown in FIG. 3b, the method may include the more granular steps of obtaining floorplan data 308, converting the floorplan data into a common format 310, obtaining categorization and characterization information relating to the floorplan data 312, including information about the number of rooms, the function of the rooms, the number of floors, the industry pertaining to the building, how many units of equipment and supply are recommended, and where installation of the equipment is recommended. Additional steps include passing the floorplan data into a first stream of a neural network 314 and the corresponding categorization and characterization information into a second stream 316 to supervise training.

As shown in FIG. 3c, the floorplan may first pass through a set of layers configured to identify macro structures, such as walls and doors 318. Next, the floorplan may pass through a set of layers configured to identify the function of the rooms based on the arrangement of the walls, the square footage, and floorplan symbols 320. After that, the floorplan may pass through a set of layers configured to predict the recommended location for various pieces of equipment 322. The following set of layers may be configured to predict the recommended quantity of various supplies 324. Meanwhile, the information in the second stream helps calibrate the weights of various nodes 326. Finally, the neural network outputs an annotated floorplan identifying where the equipment should be installed and a corresponding document with the number of recommended supplies.

In one variation, supplies and equipment recommendations are made using two separate neural network programs, in which one trains on predicting equipment installation locations and the other trains on predicting supply recommendations. The neural networks may be coordinated to exchange information at certain stages of training, with a subset of the trained data of one entering into a supervisory stream of the other.

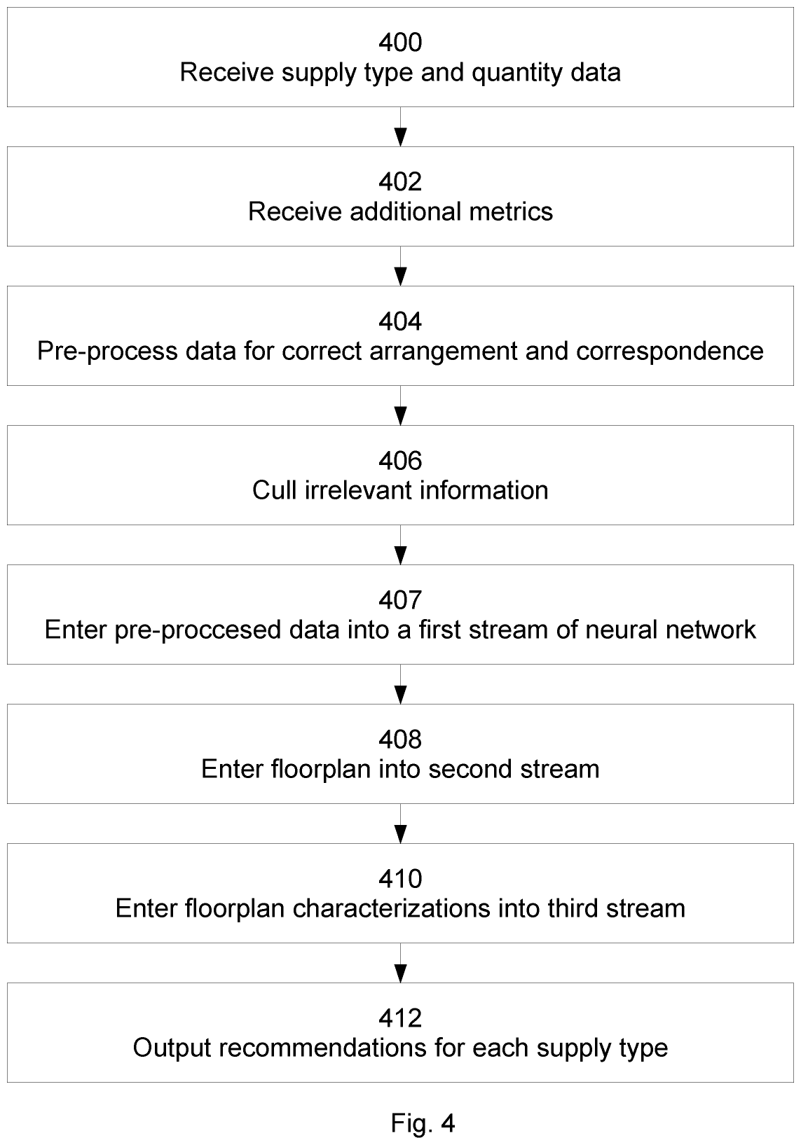

As shown in FIG. 4, the neural network configured to recommend supplies may comprise the steps of receiving supply type and quantity data for businesses 400 along with various other metrics 402, such as the number of employees, the average number of visitors/clients, or customers, the industry of a business, and geographic location of the business. Then the data is pre-processed so that the supply data and other metric data are arranged in correct correspondence 404, with irrelevant information being culled 406 based on predetermined parameters. The pre-processed data is then entered into a first stream of a predictive neural network 407, with a second stream comprising corresponding floorplan data 408 and a third stream comprising categorization or characterization data, such as the number of bathrooms, the number of common areas, etc. 410. The output may comprise recommendations for each supply type 412.

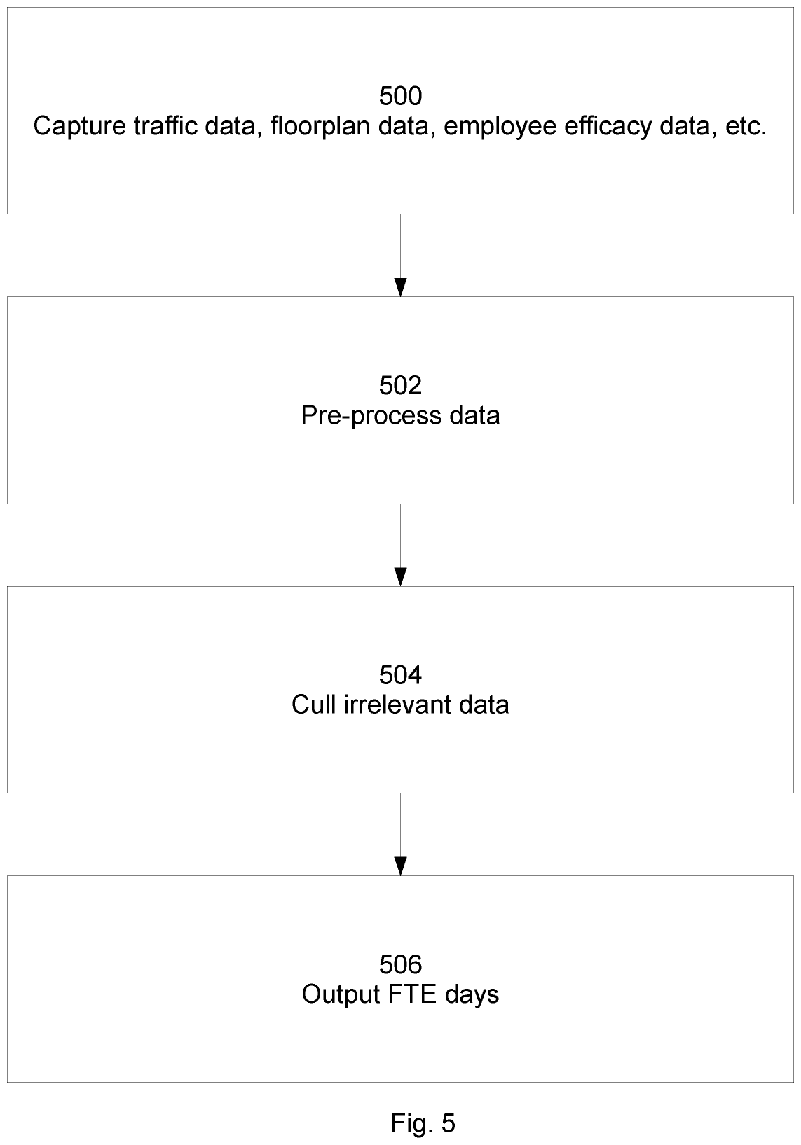

As shown in FIG. 5, the neural network configured to predict the work-hours impact of distancing and other safety requirements may comprise the steps of capturing traffic data (such as employee commute durations), floorplan data (such as the presence and existence of elevators, escalators, entrances, etc.), employee efficacy data (based on metrics such as “tasks completed”), employee work conditions data (such as whether employees are working from home, time spent in teleconference meetings, whether employees call out sick, et. al.), and other data that is possibly affected by pandemic conditions 500. The data may be pre-processed 502 and be culled for irrelevant data 504. The neural network is configured to output 506 FTE days due to remote location inefficiencies, social distancing, and decreased sick leave. In place of employees, this neural network can also train on and predict teacher-student progress.

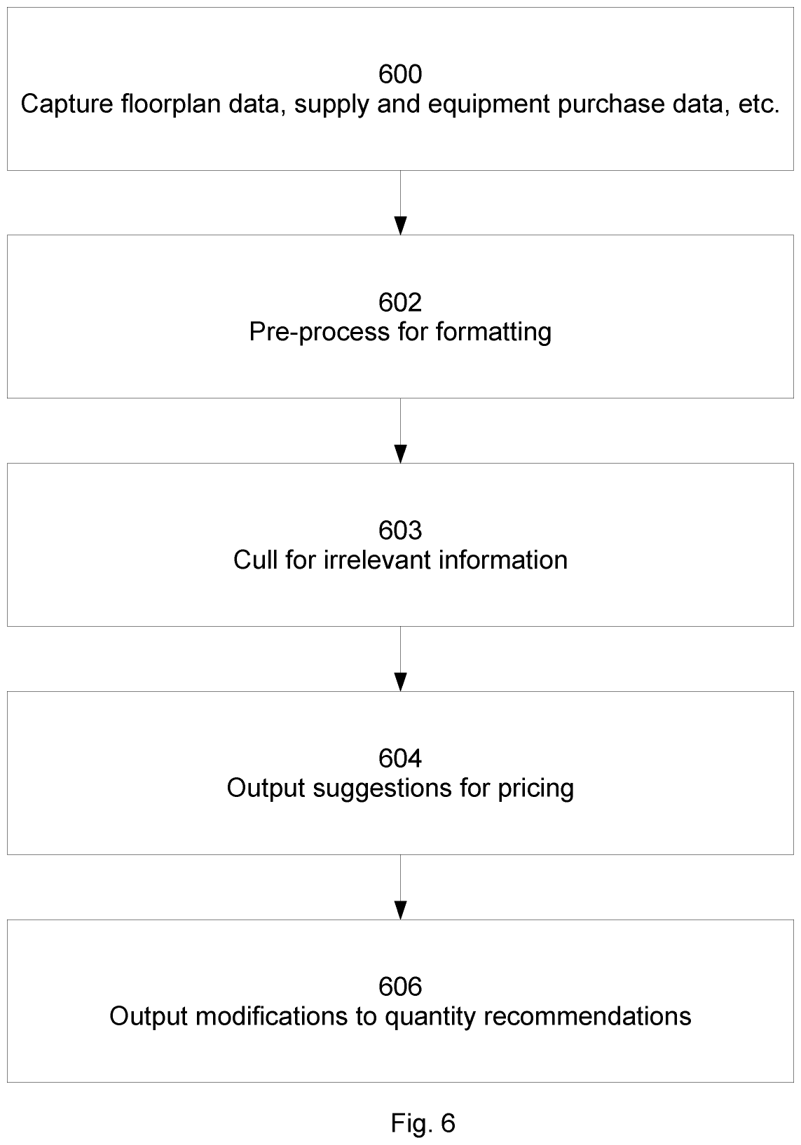

As shown in FIG. 6, the neural network configured to predict or make suggestions to optimize procurement patterns may comprise the steps of capturing 600 floorplan data, supply and equipment purchase data, the date on which purchases were made, prior recommendations made by the platform for the same, changes to the recommendations, as well as pandemic/demographic data, such as the number of new cases of confirmed infection, the number of people who have died, and finally, changes to the rules and regulations, such as which types of businesses are permitted to remain open, crowd size, etc. The data may be pre-processed for formatting correspondence of the data 602 and culled for irrelevant information 603. The neural network is configured to output suggestions of pricing 604 and modifications to quantity recommendations 606. The output data may be tethered to outbreak data by means of a tracking algorithm.

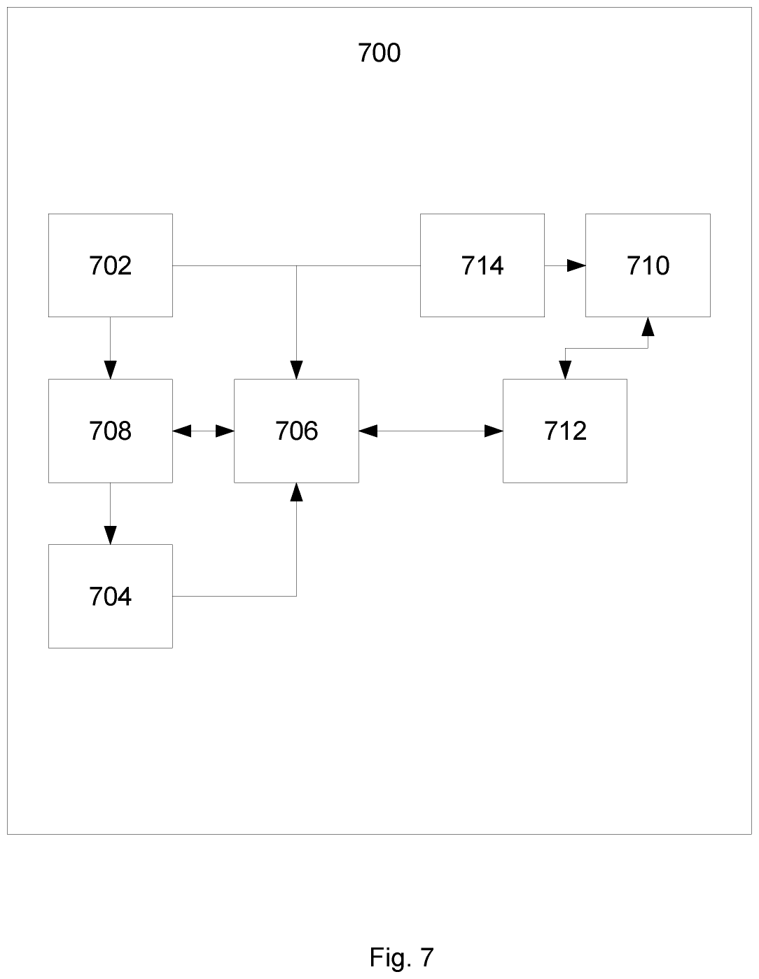

As shown in FIG. 7, the system 700 may comprise an initial data acquisition component 702 and a location parameter modification component 704, both being informationally connected to a training data acquisition component 706, which in turn is informationally connected to a location parameter prediction neural network 708. The initial data acquisition component is also connected to the location parameter prediction neural network. The system may also comprise a marketplace platform 710 connected to a product requirement prediction neural network 712, and product modification component 714, which may be connected to both the marketplace platform and the product requirement prediction neural network. The product modification component and the product requirement prediction neural network may both be connected to the training data acquisition component.

The initial data acquisition component may be configured to transmit location data entries and the location parameter modification component may be configured to transmit location parameter modification data to the training data acquisition component, which are then added by the training data acquisition component to a set of training data. The location parameter prediction neural network, which was previously trained to predict location parameter data using location data entries, may receiving additional training using the training data transmitted by the training data acquisition component. The initial data acquisition component may transmit initial location data entries to the location parameter prediction neural network, which may return location parameter data.

Both the location parameter data and the location data entries may be transmitted to the product requirement neural network, which was previously trained to predict a location's needs for products based on the location data entries and the location parameter data. Thus, the product requirement neural network may return product requirement data, including product type and product quantities required. This product requirement data may receive modifications from the product requirement modification component, and the modified product requirement data may be transmitted to the training data acquisition component to combined with location parameter data and location data entries to form additional training data for the product requirement prediction neural network.

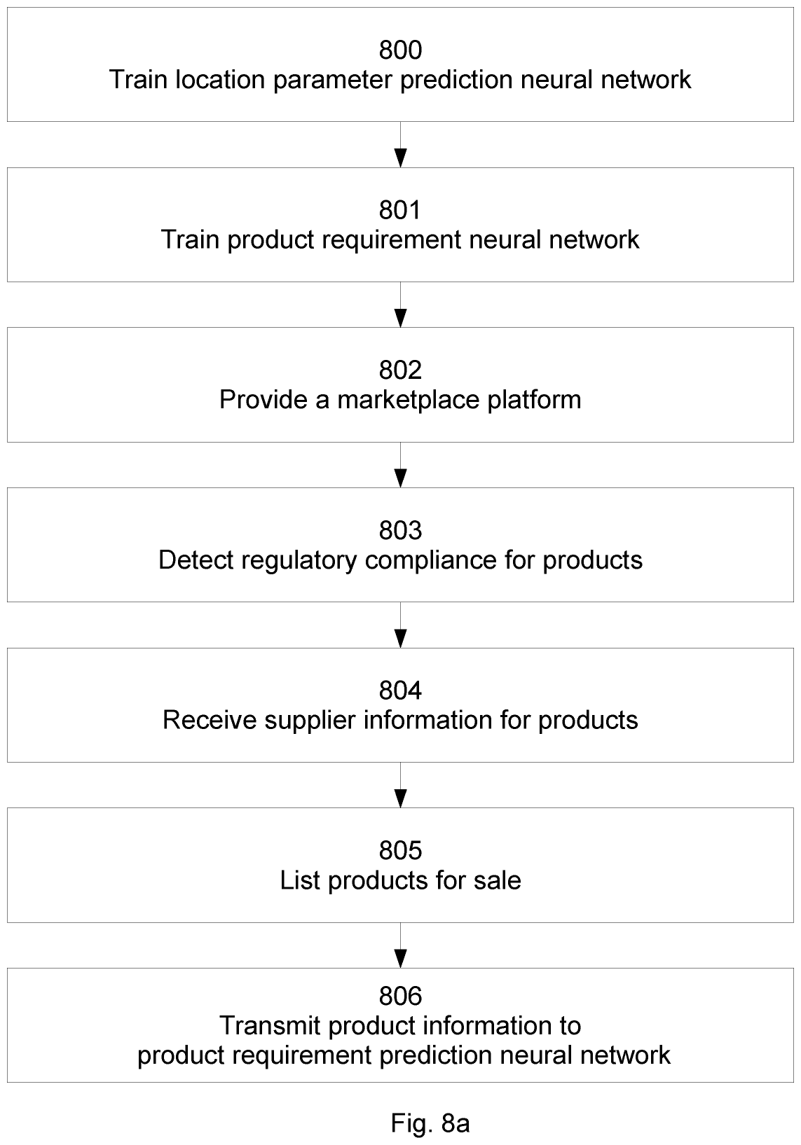

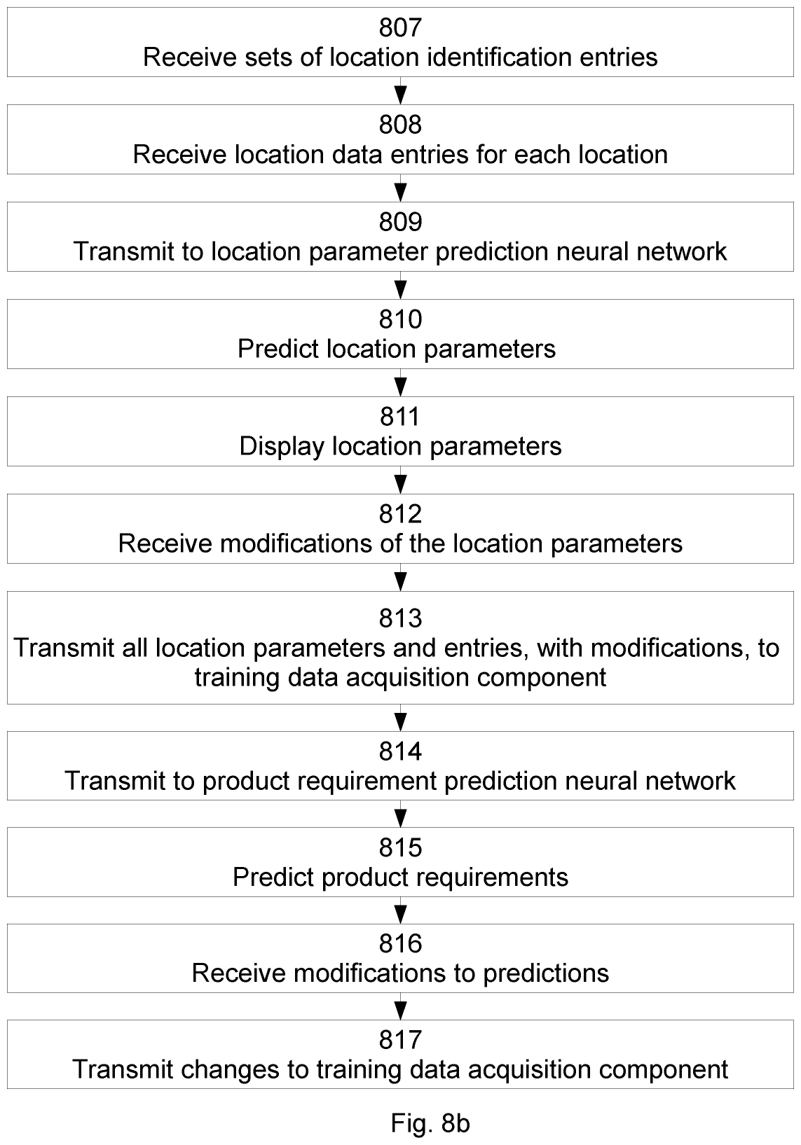

As shown in FIG. 8a, the system may be configured to train a location parameter prediction neural network 800 using training data consisting of location data entries, which is expected to be supplied by a user, and location parameter data, which is the desired output of the location parameter neural network. The system may be configured to train a product requirement neural network 801 using training data consisting of location parameter data and location data entries, product data and supplier information about the product, and product type and quantity data, which is the desired output of the product requirement neural network.

The system may provide a marketplace platform 802, which may be configured to detect regulatory compliance for a product 803, and then if the product is determined to comply, receive from a supplier information about the square footage, the period of time, the number of individuals, and/or the number or uses for which the product is suitable 803, and then list the product for sale 804. The listed products and the supplier information may be transmitted to the product requirement neural network 806.

As shown in FIG. 8b, the initial data acquisition component is configured to receive sets of location identification entries 807 and location data entries for each location 808 from a buyer on the system's platform. The location identification entries identify a location, such as by address or name. The location data entries contain information about each location which is pertinent to the product requirements of the location, and it may include the number the number of daily customers or visitors to each location, the number of teachers, employees, or other workers expected on a daily basis at each location, the number of employees or workers who have a heightened need for products, such as nurses needing protective equipment, and the number of floors or square footage of each location.

The location identification entries and location data entries are transmitted to the location parameter prediction neural network 809, which then predicts location parameters that are expected to be true for each location 810. These location parameters may include the number of offices, rooms, or classrooms of various types at each location, the number of hallways, auditoriums, lounges, cafeterias, recreational rooms, and bathrooms, and the number of elevators, escalators, and stairs. These location parameters are then displayed 811. A modification component may receive modifications of the location parameters by the user 812, which are then sent with the location data entries to a training data acquisition component 813 to be incorporated into additional training data.

Location parameters and the location data entries are then transmitted to the product requirement neural network 814, which then predicts the products required for each location 815. These predictions may be modified by a modification component 816, with the modifications comprising product type and quantity. The modifications are then transmitted to the training data acquisition component to 817 to be incorporated into additional training data.

The location parameter neural network may be configured to assign ranks to the location data entries to identify the influence the location data entries have over the location parameter predictions. This may be achieved by adding a ranking layer consisting of nodes of various weights to test and determine different weights by which the use of a location data entry variable is multiplied before calculating the location parameter predictions. The location parameter predictions in which the influence weight is used may be compared to the location parameter predictions in which the influence weight is not used to determine the significance of any particular iteration's weighting arrangement. The product requirement prediction neural network may be similarly configured to assign ranks to both the location data entries and the location parameters to determine the significance they have over the product requirement predictions.

The platform may comprise a search interface, which is configured to receive keyword requests, search platform pages based on the keywords, and display links to platform pages with descriptions thereof based on the ranking of the platform pages. The descriptions may include text snippets found on the platform pages which contain one or more of the keywords sought. Ranking may be calculated based on the association between the keywords sought and the page, which may in turn be based on the frequency with which those keywords occur on the page as well as the frequency with which users access the page. Ranking may also be at least in part pre-set by platform administrators, or based on page proximity to a “home” page. The search interface may be built based on the Javascript Libraries of React.js.

The platform may comprise a header, which is configured to pervade the platform pages. The header provides access to one or more primary platform page links, interfaces, or functionalities applicable during the display of all platform interfaces, such as the search functionality delivered by the search interface, as well as relevant content, such as an informational video. The informational video would ideally explain to a user how to navigate the platform. The video may be spatially separated from the platform interfaces and remain in the header, or it may extend as a semi-transparent layer across any given platform interface in order to highlight or explain platform page features. This semi-transparent layer may comprise mostly empty space in order to not obstruct platform interface features, with highlights or arrows to serve as indications of instructions or explanations to the user. The video may comprise text overlays that appear all at once, or letter-by-letter or word-by-word, in order to create the impression that the instructions or explanations are being communicated in real time, as if by a live assistant. The explanations may be designed to communicate the purpose or significance of platform interface features, and the instructions may convey the order by which the user should enter data or make selections. The video may be embedded or hosted on the platform server. The video may comprise one single track, or multiple tracks arranged sequentially. In one variation, the video is broken into logically and hierarchically arranged “paths”, with each path comprising a set of video sections. A given path triggered by user interactions.

The header may incorporate branding information such as the platform logo, which in turn may operate as a hyperlink to the home page. In one variation, the logo-hyperlink operates as a “reset” on the buyer's application process or other interface engagements. The header may be built using React.js.

The platform may comprise a sponsorship/endorsement section which displays the identities, via logos, of organizations that support the platform. These logos may be stored as images and incorporated directly onto a platform page. The logos may be updated manually by a platform administrator, or may automatically populate based on endorsements received from sponsors via an endorsement interface. The endorsement interface may be part of the portals referenced above, or may be accessed via separate and dedicated endorsement portal.

1. A system for predicting in real-time protective equipment and inventory supply requirements comprising:
a. an initial data acquisition component, the initial data acquisition component connected to a user interface and configured to receive a set of locations and initial location parameter entries for each location in the set of locations, the initial location parameter entries comprising:
i. a number of students attending a school, a number of teachers teaching at the school, a number of nurse suites in the school, a number of non-teacher staff working at the school, and a number of floors of the school;
b. a first neural network algorithm, the first neural network algorithm being informationally connected to the initial data acquisition component and previously trained to, upon receiving the initial location parameter entries, calculate in real-time location parameter values, the location parameter values comprising:
i. a number of standard classrooms in the school, a number of gymnasiums in the school, a number of libraries in the school, a number of auditoriums in the school, a number of teacher lounges in the school, a number of elevators in the school, a square footage of kitchen in the school, a number of offices in the school, a number of kindergarten and pre-school classrooms in the school, a number of cafeterias in the school, a number of recreational rooms in the school, a number of special education rooms in the school, a number of staircases in the school, a square footage of the school, a number of hallways in the school, a number of teacher bathrooms in the school, and a number of doors providing access to the school;
c. the initial data acquisition component configured to: display on the user interface the location parameter values calculated by the first neural network algorithm for each location, and receive user changes to the location parameter values;
d. a training data acquisition component configured to: receive for each location the initial location entries, the location parameter values, and the user changes to the location parameter values and to add the initial location entries, the location parameter values, and the user changes to the location parameter values to training data for the first neural network algorithm;
e. a marketplace platform configured to, after detecting regulatory compliance for a set of protective equipment and inventory, display listings of the protective equipment and inventory, with each listing comprising price parameters, a sourcing parameter, and target parameters, the target parameters identifying a quantity of individuals, a number of uses, a time period, or square footage for which the protective equipment and inventory are suitable;
f. a second neural network algorithm, the second neural network algorithm being informationally connected to the initial data acquisition component and the marketplace platform, and previously trained to, upon receiving the initial location entries and the location parameter values, calculate in real-time a set of protective equipment and inventory recommendations and quantity parameters for the set of protective equipment and inventory recommendations per unit of time, and transmit the recommendations to the marketplace platform;
i. where the unit of time may be set by default equal to or greater than a minimal unit of time, with the minimal unit of time being set by regulatory compliance;
g. the marketplace platform configured to display on the user interface the set of protective equipment and inventory recommendations, the quantity parameters, and the price parameters for the set of protective equipment and inventory recommendations per unit of time;
h. a first modification component, the first modification component being informationally connected to the second neural network algorithm and configured to receive sourcing preferences and adjust the set of protective equipment and inventory recommendations using the sourcing preferences;
i. where sourcing preferences include selecting between equipment and inventory sourced locally or sourced cheaply.
i. a second modification component, the second modification component being informationally connected to the second neural network algorithm, configured to receive quantity adjustments, and to modify quantity parameters for the set of protective equipment and inventory recommendations using the quantity adjustments;
j. the training data acquisition component configured to receive the initial location entries, the location parameter values, the set of protective equipment and inventory recommendations, the quantity adjustments, and the sourcing preferences, and to add the initial location entries, the location parameter values, the set of protective equipment and inventory recommendations, the quantity adjustments, and the sourcing preferences to training data for the second neural network algorithm;
k. where the first and second neural network algorithms may each comprise one or more hidden layers and at least one neuron within each layer.

2. A system for predicting in real-time product supply requirements comprising:
a. an initial data acquisition component, the initial data acquisition component connected to a user interface and configured to receive a set of locations and initial location parameter entries for each location in the set of locations;
b. a first neural network algorithm, the first neural network algorithm being informationally connected to the initial data acquisition component and previously trained to, upon receiving the initial location parameter entries, calculate in real-time location parameter values;
c. the initial data acquisition component configured to: display on the user interface the location parameter values calculated by the first neural network algorithm for each location, and receive user changes to the location parameter values;
d. a marketplace platform configured to, after detecting regulatory compliance for a set of products, display listings of the products, with each listing comprising price parameters and target parameters, the target parameters identifying a quantity of individuals, a number of uses, a time period, or square footage for which the products are suitable;
e. a second neural network algorithm, the second neural network algorithm being informationally connected to the initial data acquisition component and the marketplace platform, and previously trained to, upon receiving the initial location entries and the location parameter values, calculate in real-time a set of product recommendations and quantity parameters for the set of product recommendations per unit of time, and transmit the recommendations to the marketplace platform;
f. the marketplace platform configured to display on the user interface the set of product recommendations, the quantity parameters, and the price parameters for the set of product recommendations per unit of time;
g. where the first and second neural network algorithms may each comprise one or more hidden layers and at least one neuron within each layer.

3. The system of claim 2, where the initial locations entries comprise: a number of individuals expected at each location.

4. The system of claim 2, where the location parameter values comprise: a number of rooms at each location, and a square footage of each location, a number of bathrooms at each location, and a number of entries into the location.

5. The system of claim 2, additionally comprising a training data acquisition component, the training data acquisition component configured to: receive for each location the initial location entries, the location parameter values, and the user changes to the location parameter values and to add the initial location entries, the location parameter values, and the user changes to the location parameter values to training data for the first neural network algorithm.

6. The system of claim 2, additionally comprising a training data acquisition component, the training data acquisition component configured to: receive the initial location entries, the location parameter values, the set of products recommendations, and the quantity adjustments, and to add the initial location entries, the location parameter values, the set of product recommendations, and the quantity adjustments to training data for the second neural network algorithm.

7. The system of claim 2, where the unit of time may be set equal to or greater than a minimal unit of time, with the minimal unit of time being set by regulatory compliance.

8. The system of claim 2, with each listing additionally comprising sourcing parameters and the system additionally comprising a modification component, the modification component being informationally connected to the marketplace platform and configured to receive sourcing preferences and adjust the set of product recommendations using the sourcing preferences and the sourcing parameters.

9. The system of claim 2, the system additionally comprising a modification component, the modification component being informationally connected to the marketplace platform and configured to receive quantity adjustments and to modify the quantity parameters for the set of product recommendations using the quantity adjustments.

10. A system for recommending product purchases comprising:
a. an initial data acquisition component connected configured to receive initial location parameter entries;
b. a marketplace platform configured to display listings of products;
c. a first neural network algorithm, the first neural network algorithm being informationally connected to the initial data acquisition component and the marketplace platform and previously trained to, upon receiving the initial location entries, calculate in real-time product recommendations and quantity parameters for the product recommendations and transmit the product recommendations to the marketplace platform;
d. the marketplace platform configured to display the product recommendations and the quantity parameters.

11. The system of claim 10, the system additionally comprising a second neural network algorithm, the second neural network algorithm being informationally connected to the initial data acquisition component and previously trained to, upon receiving the initial location parameter entries, calculate in real-time location parameter values;
a. with the initial data acquisition component configured to: display the location parameter values calculated by the second neural network algorithms and receive user changes to the location parameter values;
b. with the first neural network algorithm being trained to, after receiving the location parameter values, calculate in real-time the product recommendations and quantity parameters for the product recommendations.

12. The system of claim 10, where the marketplace platform is configured to display listings of the products only after detecting regulatory compliance for the set of products.

13. The system of claim 12, the system additionally comprising a regulatory compliance sourcing component, the regulatory compliance sourcing component configured to: perform a database search using a sourcing parameter for a product to determine a legal jurisdiction covering product and regulatory compliance rules pertaining to the legal jurisdiction.

14. The system of claim 10, where each listing comprises price parameters and target parameters, the target parameters identifying a quantity of individuals, a number of uses, a time period, or square footage for which the products are suitable.

15. The system of claim 10, where the initial location parameter entries comprise an address and the system additionally comprises a location analysis component, the location analysis component configured to: perform a database search using the address to determine an industry type associated with the address, a square footage associated with the address, and a number of individuals expected daily at the address, and add the industry type, the square footage, and the number of individuals expected daily at the address into the initial location parameter entries.

16. The system of claim 10, the system additionally comprising a modification component, the modification component being informationally connected to the marketplace platform and configured to receive sourcing preferences and adjust the product recommendations using the sourcing preferences.

17. The system of claim 16, where sourcing preferences include selecting between products sourced locally or sourced cheaply.

18. The system of claim 10, the system additionally comprising a modification component, the modification component being informationally connected to the marketplace platform and configured to receive quantity adjustments and to modify the quantity parameters for the product recommendations using the quantity adjustments.

19. The system of claim 5, where the first neural network algorithm comprises a ranking layer and input streams for each initial location entry and is configured to assign ranks to the initial location entries based on degrees to which each initial location entry influences the location parameter values.

20. The system of claim 6, where the first neural network algorithm comprises a ranking layer and input streams for each location parameter value and initial location entry and is configured to assign ranks to the initial location entry streams and the location parameter value streams based on degrees to which data entered into the initial location entry streams and location parameter value streams influence the product recommendations.
